(19) United States
(12) Patent Application Publication
(10) Pub. No.: US 2007/0165157 A1
(43) Pub. Date: Jul. 19, 2007

(54) APPARATUS AND METHOD FOR MANUFACTURING POLARIZER

(75) Inventor: Kweon Sam HONG, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-Si (KR)

(21) Appl. No.: 11/610,543

(22) Filed: Dec. 14, 2006

(30) Foreign Application Priority Data
Jan. 19, 2006 (KR) 10-2006-0005795

(51) Int. Cl. G02F 1/1335

(52) U.S. Cl. 349/96

(57) ABSTRACT

A method and apparatus for manufacturing a polarizer for use in a large-sized liquid crystal display (LCD) with a size of 60 inches or more includes controlling the degree of stretching of a PVA film to have a width corresponding to a length of a long side of an LCD panel, cutting the stretched PVA film to fabricate PVA sheets, and attaching TAC films and protection films to each of the PVA sheets. Since the PVA film is fabricated into the PVA sheets, it is possible to fabricate a polarizer without changing the widths of the TAC films and protection films. Therefore, costs can be reduced that are associated with facility investment for manufacturing polarizers for LCDs having a size of 60 inches or more.

This application claims priority to Korean Patent application No. 10-2006-0005795, filed on Jan. 19, 2006, and all the benefits accruing therefrom under 35 U.S.C. §119, the contents of which in its entirety are herein incorporated by reference.

### BACKGROUND OF THE INVENTION

1. Field of the Invention

The present invention relates to an apparatus and method for manufacturing a polarizer, and more particularly, to a method for manufacturing a polarizer used in a liquid crystal display with a large size of 60 inches or more and an apparatus for manufacturing the polarizer.

2. Description of the Related Art

A liquid crystal display (“LCD”) is a flat panel display that is widely used due to its low operating voltage, low power consumption and portability in view of weight and volume. However, the LCD needs a backlight because it does not have self-luminance contrary to a conventional cathode ray tube (“CRT”).

Contrary to the conventional CRT that projects an electron beam from one point so as to cause R, G and B phosphors to emit light, an LCD uses light from a backlight that is turned on and off. Light has waves vibrating in all directions. When light arrives at a filter, only the wave vibrating in a specified direction can pass through the filter. Therefore, an LCD displays a desired image by allowing the orientation of liquid crystal molecules to be changed in a certain direction by an electric field and allowing light with waves in the certain direction to selectively pass through three sub-pixels of R, G and B.

Such an LCD includes a lower glass substrate on which thin film transistors (“TFTs”) and pixel electrodes are arranged, an upper glass substrate having color filters and common electrodes, liquid crystals filled into a space between these two glass substrates, and polarizers mounted on both surfaces of the two glass substrates to polarize visible rays.

Recently, due to a desire to increase the size of an LCD, the length of a long side of an LCD panel has become longer than the width of polarizer sheet that is currently mass-produced. That is, there is a problem in that a size of current polarizers does not conform to the increase in size of LCD panels.

### BRIEF SUMMARY OF THE INVENTION

The present invention solves the aforementioned problem in the art. The present invention provides an apparatus and method for manufacturing a polarizer for an LCD, wherein a polarizer for a large-sized LCD can be manufactured by controlling elongation of a polyvinyl alcohol (“PVA”) film and cutting the PVA film into sheets, without modifying other materials and facilities.

To achieve this aspect, the present invention provides a method for manufacturing a polarizer for an LCD panel, including preparing a PVA film; dyeing a dichroic element on a surface of the PVA film, and stretching the dyed PVA film to have a width corresponding to a long side of the LCD panel; fabricating a PVA sheet by cutting the stretched PVA film to the length of a short side of the LCD panel; and sequentially attaching triacetyl cellulose (“TAC”) films and protection films on upper and lower surfaces of the PVA sheet.

According to exemplary embodiments of the present invention, attaching the TAC films to the upper and lower surfaces of the PVA sheet includes attaching the TAC films unwound from rolls of TAC film to the upper and lower surfaces of the PVA sheet; and removing portions of the TAC films outside of the PVA sheet.

Preferably, before attaching the TAC films unwound from the rolls of TAC film to the upper and lower surfaces of the PVA sheet, the method further includes causing a short side of the PVA sheet to correspond to the width of the TAC films unwound from the rolls of TAC film.

According to another exemplary embodiment of the present invention, attaching the TAC film to the upper and lower surfaces of the PVA sheet preferably includes fabricating TAC sheets by cutting the TAC films unwound from the rolls to the size of the LCD panel; and then attaching the TAC sheets to the upper and lower surfaces of the PVA sheet.

According to exemplary embodiments of the present invention attaching the protection films to the TAC films attached to the PVA sheet preferably includes attaching the protection films unwound from rolls to exposed upper and lower surfaces of the TAC films and removing portions of the protection films outside of the PVA sheet. According to another exemplary embodiment of the present invention, attaching the protection films to the TAC films attached to the PVA sheet may include fabricating protection sheets by cutting the protection films unwound from the rolls to the size of the LCD panel; and then attaching the protection sheets to the exposed upper and lower surfaces of the TAC films.

In exemplary embodiments, after stretching the PVA film, the method further includes attaching polyethylene (“PE”) films to the upper and lower surfaces of the PVA film. After fabricating the PVA sheet, the method further includes removal of the PE films.

Attaching the TAC films to the upper and lower surfaces of the PVA sheet preferably includes removing the PE film from either the upper or lower surface of the PVA film; attaching one of the TAC films to the surface of the PVA film from which the PE film has been removed; removing the other PE film remaining on the other surface of the PVA film; and attaching the TAC film to the other face of the PVA film from which the other PE film has been removed.

According to a still another exemplary embodiment of the present invention, the method may further include winding a PVA sheet with the TAC films and the protection films sequentially attached to the upper and lower surfaces thereof into a roll.

In exemplary embodiments, the width of the stretched PVA film is about 1 percent to about 30 percent larger than the length of the long side of the LCD panel.

In exemplary embodiments, the dichroic element is arranged in a direction in which the PVA film is stretched.

An exemplary embodiment of the present invention provides a method for manufacturing a polarizer for an LCD panel, including preparing a PVA film; dyeing a dichroic element on a surface of the PVA film and stretching the dyed PVA film to form a light absorbing layer in a direction perpendicular to the stretching direction; and sequentially attaching TAC films and protection films to upper and lower surfaces of the stretched PVA film.

The width of the stretched PVA film corresponds to the length of a short side of the LCD panel, and the PVA film with the TAC films and protection films attached thereto is cut to the length of a long side of the LCD panel.

The polarizer is preferably manufactured by means of a roll-to-roll process.

Another exemplary embodiment of the present invention provides a method for manufacturing a polarizer for an LCD, including the method includes preparing a PVA film with a first width larger than a long side of the LCD, TAC films with a second width smaller than the long side of the LCD, and protection films with a third width smaller than the long side of the LCD; stretching the PVA film with the first width to form a PVA film with a fourth width equal to or larger than the long side of the LCD; cutting the PVA film with the fourth width to a length smaller than the second and third widths; and attaching the TAC films with the second width and the protection films with the third width to upper and lower surfaces of the cut PVA film.

The length smaller than the second and third widths is preferably equal to or larger than the length of a short side of the LCD. The second width and the third width may be equal to the length of a short side of the LCD. Preferably, the first width is about 2,000 mm to about 4,000 mm, and the fourth width is about 1,000 mm to about 3,000 mm.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 is a conceptual perspective view of an exemplary embodiment of a liquid crystal display (LCD) according to the present invention;

FIG. 2 is a conceptual cross-sectional view of an exemplary embodiment of a polarizer according to the present invention;

FIG. 3 is a schematic illustration of an exemplary embodiment of a method for manufacturing the polarizer according to the present invention;

FIGS. 4 to 8 are conceptual cross-sectional views illustrating the polarizer during manufacture of the polarizer according to the method exemplified in FIG. 3;

FIG. 9 is a schematic illustration of another exemplary embodiment of a method for manufacturing a polarizer according to the present invention;

FIGS. 10 to 12 are conceptual cross-sectional views illustrating the polarizer during manufacture of the polarizer according to the method exemplified in FIG. 9;

FIG. 13 is a schematic illustration of another exemplary embodiment of a method for manufacturing a polarizer according to the present invention;

FIG. 14 is a schematic illustration of still another exemplary embodiment of a method for manufacturing a polarizer according to the present invention;

FIG. 15 is a schematic illustration of yet another exemplary embodiment of a method for manufacturing a polarizer according the present invention;

FIG. 16 is a schematic illustration of a further exemplary embodiment of a method for manufacturing a polarizer according to the present invention; and

FIG. 17 is an enlarged view of a circled portion of the polarizer in FIG. 16.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

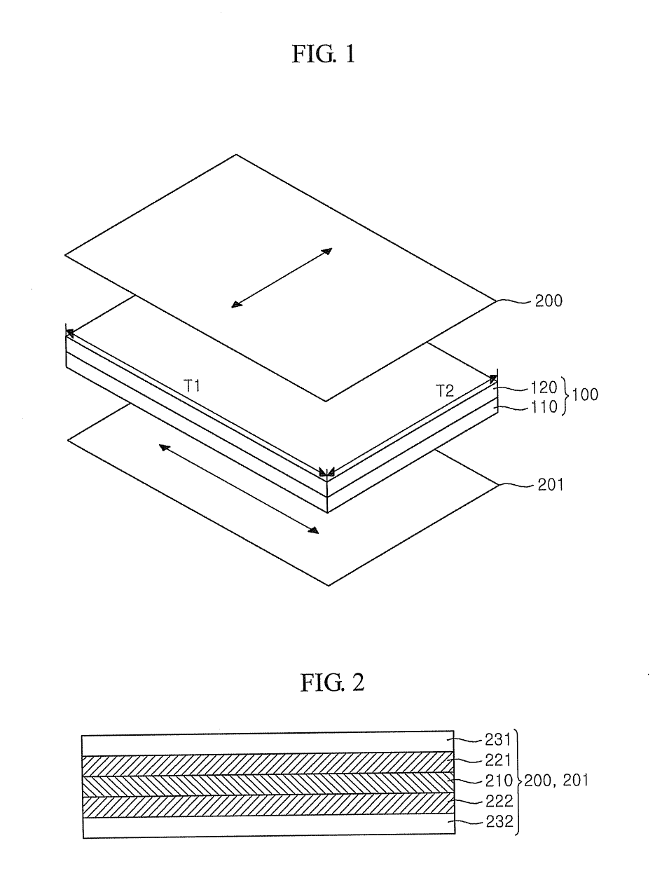

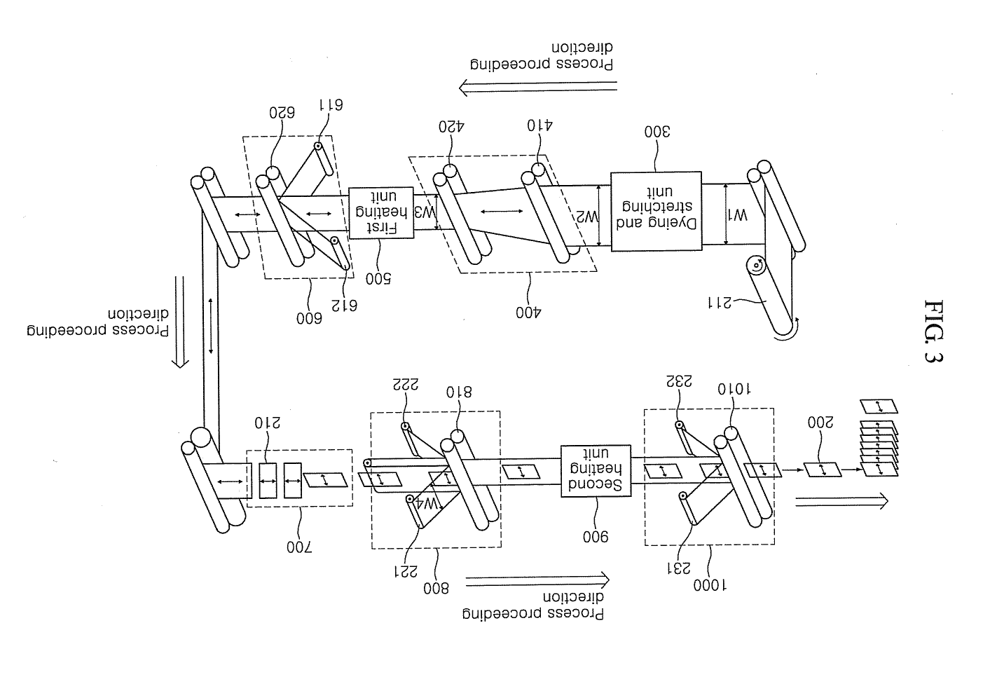

FIG. 1 is a conceptual perspective view of an exemplary embodiment of a liquid crystal display (“LCD”) according to the present invention, and FIG. 2 is a cross-sectional view of an exemplary embodiment of a polarizer according to the present invention.

Referring to FIGS. 1 and 2, the an exemplary embodiment of an LCD according to the present invention includes a rectangular LCD panel 100 with a long side T1 and a short side T2, and first and second polarizers 200 and 201 formed on upper and lower surfaces, respectively, of the LCD panel 100.

The LCD panel 100 includes a thin film transistor (“TFT”) substrate 110 on which pixel electrodes and TFTs are provided, a common electrode substrate 120 on which color filters and common electrodes are provided and a liquid crystal layer formed between the substrate 110 and substrate 120.

The TFT substrate 110 is a rectangular transparent glass substrate on which TFTs are disposed in a matrix form, wherein data lines connected to source terminals of the TFTs and gate lines connected to gate terminals of the TFTs are included on the TFT substrate 110. Pixel electrodes including transparent electrodes formed of a transparent conductive material are formed in pixel regions defined by the gate lines and the data lines, and the pixel electrodes are connected to drain terminals of the TFTs.

The common electrode substrate 120 includes a black matrix pattern for preventing light leakage; R, G and B color filters corresponding to the pixel regions; and common electrodes corresponding to the pixel electrodes.

In the LCD panel 100, an electric field is formed between the pixel electrodes and the common electrodes when the TFTs are turned on by applying signals to the gate lines and the data lines of the TFT substrate 110. The electric field changes an orientation of liquid crystals of the liquid crystal layer between the two substrates 110 and 120, and subsequently the changed orientation of the liquid crystals changes light transmittance. Accordingly, the LCD panel 100 controls the amount of light from a backlight installed below the LCD panel to be transmitted through the R, G and B color filters so that a desired image can be obtained.

The LCD according to this exemplary embodiment further includes a gate driving unit for applying gate signals to the gate lines of the TFT substrate 110, and a data driving unit for applying data signals to the data lines of the TFT substrate 110. These driving units may be mounted on the LCD panel 100 or electrically connected to the LCD panel 100 through additional circuit boards (not shown).

As described above, the first and second polarizers 200 and 201 are formed on the upper and lower surfaces, respectively, of the LCD panel. As shown in FIG. 1, a light absorbing layer is formed in a direction parallel to a short side of the first polarizer 200 formed on the upper surface of the LCD panel 100, and a light transmitting layer is formed in a direction parallel to a long side of the first polarizer 200. The direction of the light absorbing layer is designated by an arrow on the first polarizer 200 in FIG. 1. A light absorbing layer is formed in a long side direction of the second polarizer 201 formed on the lower surface of the LCD panel 100, and a light transmitting layer is formed in a short side direction of the second polarizer 201.

The short side direction refers to the lengthwise direction of a straight line extending parallel to the short side T2 of the LCD panel 100, and the long side direction refers to the lengthwise direction of a straight line extending parallel to the long side T1 of the LCD panel 100.

At least the first polarizer 200 of the two polarizers includes a PVA sheet 210 fabricated by stretching a polyvinyl alcohol (“PVA”) film unwound from a roll to at least a width corresponding to the length of the long side T1 of the LCD panel 100 and cutting the stretched PVA film into the length of the short side T2 of the LCD panel 100; triacetyl cellulose (“TAC”) films 221 and 222 provided on upper and lower surfaces of the PVA sheet 210; and protection films 231 and 232 provided on upper and lower surfaces of the TAC films 221 and 222, respectively.

The TAC films 221 and 222 and the protection films 231 and 232 are wound in a roll shape. The TAC films 221 and 222 and the protection films 231 and 232 have a width that is equal to or larger than the length of the short side T2 of the LCD panel 100 and shorter than the length of the long side TI of the LCD panel 100. This is because the widths of the TAC films 221 and 222 and the protection films 231 and 232 suitable for manufacturing facilities of a polarizer for an LCD are shorter than the length of the long side T1 of the LCD due to the increase in the size of the LCD as described above. For instance, if the lengths of the long side T1 and the short side T2 of the LCD are 1,450 mm and 1,080 mm, respectively, and the widths of the TAC films and the protection films are 1,450 mm, it is possible to manufacture a polarizer corresponding to the enlarged LCD. However, if the size of an LCD is increased to the long side T1 equals 1,680 mm and the short side T2 equals 1,190 mm or the long side T1 equals 2,200 mm and the short side T2 equals 1,870 mm, it is difficult to manufacture a polarizer corresponding to the enlarged LCD using the existing TAC films and protection films. Thus, according to the present invention, it is possible to manufacture a polarizer by forming the PVA film 210 into sheets, without additional manufacturing facilities for large sized TAC and protection films.

Hereinafter, an exemplary embodiment of a method for manufacturing the aforementioned polarizer will be described with reference to the accompanying drawings. The method for manufacturing the polarizer will be described focusing on a method for manufacturing the first polarizer 200 with the light absorbing layer provided in the short side direction.

FIG. 3 is a schematic illustration of an exemplary embodiment of a method for manufacturing the polarizer according to the present invention.

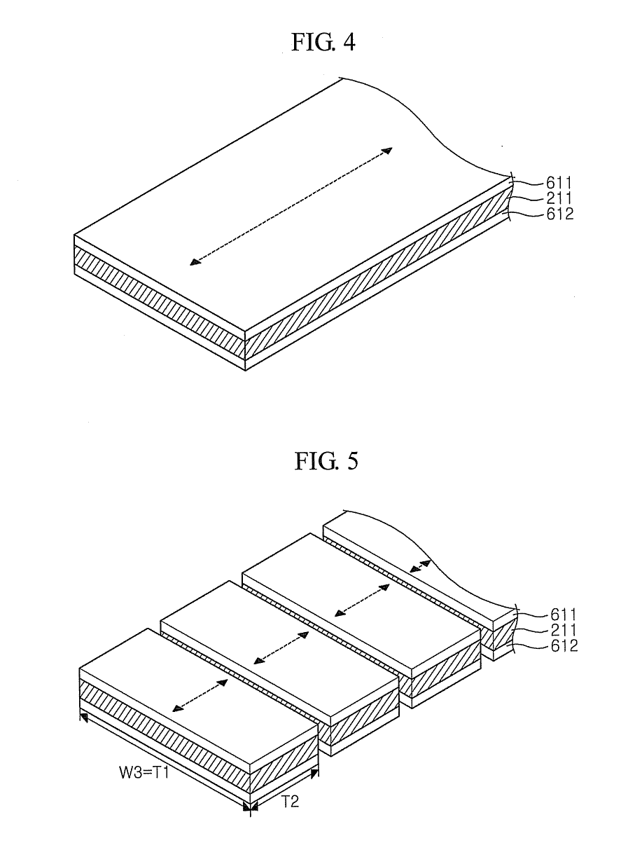

FIGS. 4 to 8 are conceptual cross-sectional views illustrating the polarizer during manufacture of the polarizer according to the method exemplified in FIG. 3.

Referring to FIGS. 3 to 8, a PVA film 211 with a first width W1 wound on a roll is prepared and then primarily stretched, and a dichroic element of iodine or dye is dyed over the primarily stretched PVA film 211.

To this end, the PVA film 211 is unwound and then dipped into an aqueous solution containing the dichroic element by using a dyeing and stretching unit 300. Here, the dyeing and stretching unit 300 includes a washing process module, a swelling process module, a dyeing process module and another washing process module. Therefore, the dyeing and stretching unit 300 can dye the dichroic element over the surface of the PVA film 211 by sequentially performing washing, swelling, dyeing and washing on the PVA film 211 that passes through these modules.

Accordingly, the PVA film 211 has a second width W2 smaller than the first width W1 after the primary stretching and dyeing process. Preferably, the first width is about 2,000 mm to about 4,000 mm.

The aforementioned process of primarily stretching the PVA film 211 in a lengthwise direction and dyeing the dichroic element over the surface of the stretched PVA film 211 is not limited to the foregoing but may be performed through various processes. Further, the dichroic element is not limited to the aforementioned iodine or dye but may be formed of various raw materials.

Thereafter, the PVA film 211 is secondarily stretched so that the dichroic element can be aligned in a direction. At this time, the dichroic element is aligned in a direction by stretching the PVA film 211 in the lengthwise direction using a stretching unit 400. Accordingly, the PVA film 211 has a third width W3 smaller than the second width W2 after the secondary stretching process. Here, the third width W3 is preferably identical to the length of the long side T1 of the LCD panel 100. It will be apparent that the third width is not limited thereto but may be adjusted to be larger than the length of the long side Ti of the LCD panel 100 by about 1 percent to about 20 percent so as to secure a processing margin. After the stretching process, a complementary color process using potassium iodide can be performed. The complementary color process is performed by dipping the stretched PVA film 211 into a solution containing potassium iodide.

The stretching unit 400 includes first rollers 410 and second rollers 420 installed at both sides of the stretching unit 400 as shown in FIG. 3.

The PVA film 211 has a light absorbing layer disposed thereon in the stretching direction (or in the lengthwise direction or in a direction perpendicular to the width direction) through the aforementioned secondary stretching. Accordingly, the PVA film 211 can have a basic property of a polarizer by which only a component of light in one direction is transmitted while the other components of light are absorbed.

Furthermore, in this exemplary embodiment, the PVA film 211 provided through the secondary stretching is formed to have the width W3 identical to or larger than the length of the long side T1 of the LCD panel 100, and the width W3 is preferably between about 1,000 mm and 3,000 mm. Dry stretching or wet stretching are examples that can be employed as the foregoing stretching process.

Next, the PVA film 211 is dehydrated by heating the film that has been completely subjected to the primary stretching process, the dichroic element dyeing process and the secondary stretching process. Namely, moisture contained in the film is removed by heating the PVA film 211 using a first heating unit 500. The dehydrating process can be eliminated if the PVA film can be sufficiently dehydrated during the secondary stretching process. Furthermore, a complementary color process using potassium iodide may be performed before the dehydrating process is performed.

Subsequently, first and second polyethylene (“PE”) films 611 and 612 are attached to upper and lower surfaces, respectively, of the PVA film 211.

The PVA film 211 may be easily damaged through subsequent processes and is thereby protected by attaching the first and second PE films 611 and 612 to the upper and lower surfaces of the PVA film 211 using an additional PE film attaching unit 600. Here, FIG. 4 is a conceptual partial perspective view illustrating an in process polarizer after the first and second PE films 611 and 612 are attached to the respective upper and lower surfaces of the PVA film 211. As illustrated in the figure, the widths of the PE films 611 and 612 may be equal to or larger than the width of the PVA film 211 disposed therebetween.

The PE film attaching unit 600 includes the first and second PE films 611 and 612 that are wound in the form of rolls respectively disposed above and below the PVA film 211, and respectively disposed above and below rollers 620 for attaching the first and second PE films 611 and 612 to the PVA film 211.

This exemplary embodiment is not limited to the foregoing and it is possible to eliminate a PE film attaching process. Furthermore, the heating process and the PE film attaching process may be interchanged, and a complementary color process using potassium iodide may be carried out after performing the heating process.

Subsequently, the PVA film 211 is cut to the length of the short side T2 of the LCD panel 100 to fabricate PVA sheets 210.

That is, the PVA film 211 with the PE films 611 and 612 attached thereto is cut using a predetermined cutting unit 700 to fabricate the PVA sheets 210, each of which has a long side T1 (=W3) and a short side T2. FIG. 5 is a conceptual partial perspective view of the PVA sheets 210 fabricated by cutting the PVA film 211. As illustrated in this figure, the long side and the short side of each of the PVA sheets 210 have lengths equal to those of the short side and the long side of the LCD panel 100, and a light absorbing layer is provided in a short side direction of the PVA sheet 210, as illustrated by an arrow on respective PE films 611.

After the cutting process, the PVA sheet 210 is rotated by 90 degrees in a plane defining the PVA sheet 210 as illustrated in FIG. 3 in order to perform a subsequent process. As described above, it is desirable to rotate the PVA sheet 210 by 90 degrees so as to attach the TAC films 221 and 222 to the PVA sheet 210, since the widths of the TAC films 221 and 222 used in this exemplary embodiment are smaller than the length of the long side T1 of the LCD panel 100.

Although not shown in the figures, the cutting unit 700 in this embodiment for performing the aforementioned process includes means for cutting the PVA film 211 into the PVA sheets 210, a feeding means for feeding the PVA sheets 210, and a means for rotating the PVA sheets 210 by 90 degrees.

Although the PVA film 211 has a property by which it is easily broken by an external impact as in the cutting process, damage to the PVA film 211 during the cutting process can be prevented by the presence of the PE films 611 and 612 attached to the PVA film 211. Since the PE films 611 and 612 can be easily fabricated to have various widths, the PE films 611 and 612 are used as layers for protecting the PVA film 211 during the cutting process in this exemplary embodiment. After performing the cutting process, it is preferred that the TAC films 221 and 222 be attached to the PVA sheet 210 after removing the PE films 611 and 612 attached to the PVA sheet 210.

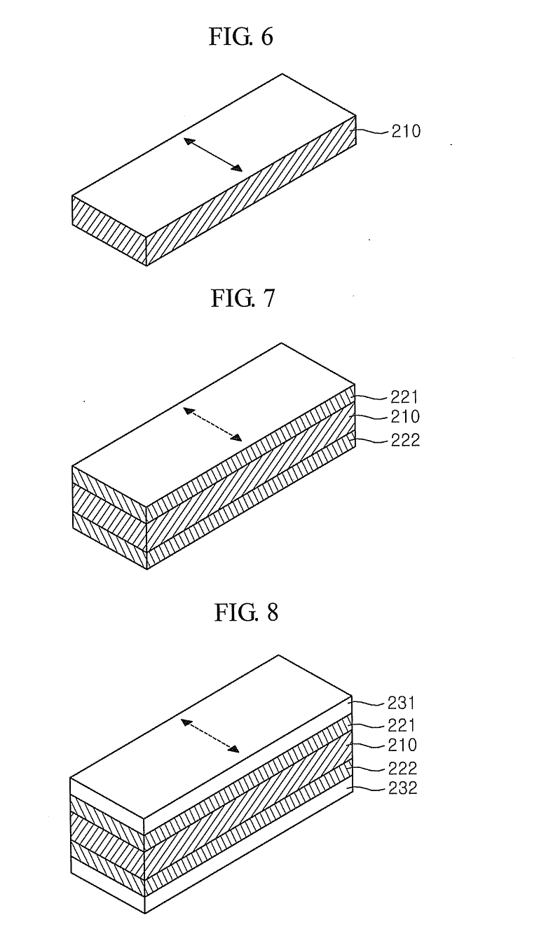

Therefore, although not shown in the figures, it is desirable to remove the PE films 611 and 612 provided on the upper and lower surfaces of the PVA sheet 210, using an additional peeling unit. FIG. 6 is a perspective view illustrating the PVA sheet 210 from which the PE films 611 and 612 have been removed. As illustrated in the figure, it is possible to prepare the PVA sheet 210 in which additional films are not attached to the upper and lower surfaces of the PVA sheet by removing the PE films 611 and 612.

Although the peeling unit for removing the PE films 611 and 612 has been used in the foregoing, the present invention is not limited thereto and the PE films 611 and 612 on the PVA sheet 210 may be removed using the cutting unit 700.

Subsequently, the first and second TAC films 221 and 222 are attached to the upper and lower surfaces of the PVA sheet 210 from which the PE films 611 and 612 have been removed.

That is, the first and second TAC films 221 and 222, which serve as mechanical supports for the PVA sheet 210, are attached to the upper and lower surfaces of the PVA sheet 210 using an additional TAC attaching unit 800. FIG. 7 is a perspective view illustrating a state of the polarizer after the first and second TAC films 221 and 222 are attached to the upper and lower surfaces of the PVA sheet 210. Since the widths W4 of the first and second TAC films 221 and 222 are larger than the length of the short side T2 of the PVA sheet 210 and smaller than the length of the long side T1 (=W3) of the PVA sheet 210, the PVA sheet 210 proceeding in the long side direction continues to proceed in the long side direction as illustrated in FIG. 3 so that the PVA sheet 210 can enter the TAC attaching unit 800 with the short side leading, thereby enabling the first and second TAC films 221 and 222 to be attached to the upper and lower surfaces of the PVA sheet 210. Accordingly, the PVA sheet 210 is provided in a central region between the two layers of TAC films 221 and 222 as illustrated in FIG. 7. At this time, the first and second TAC films 221 and 222 are attached to the PVA sheet 210 using an adhesive.

The TAC film attaching unit 800 includes the first and second TAC films 221 and 222 wound in the form of rolls disposed above and below the PVA sheet 210, and rollers 810 for attaching the first and second TAC films 221 and 222 to the PVA sheet 210. If an adhesive is used, the TAC film attaching unit 800 may further include an adhesive application means (not shown) for applying the adhesive to the first and second TAC films 221 and 222.

Subsequently, the PVA sheet 210 with the first and second TAC films 221 and 222 attached thereto is heated through a predetermined second heating process.

First and second protection films 231 and 232 are attached to the surfaces of the first and second TAC films 221 and 222, respectively.

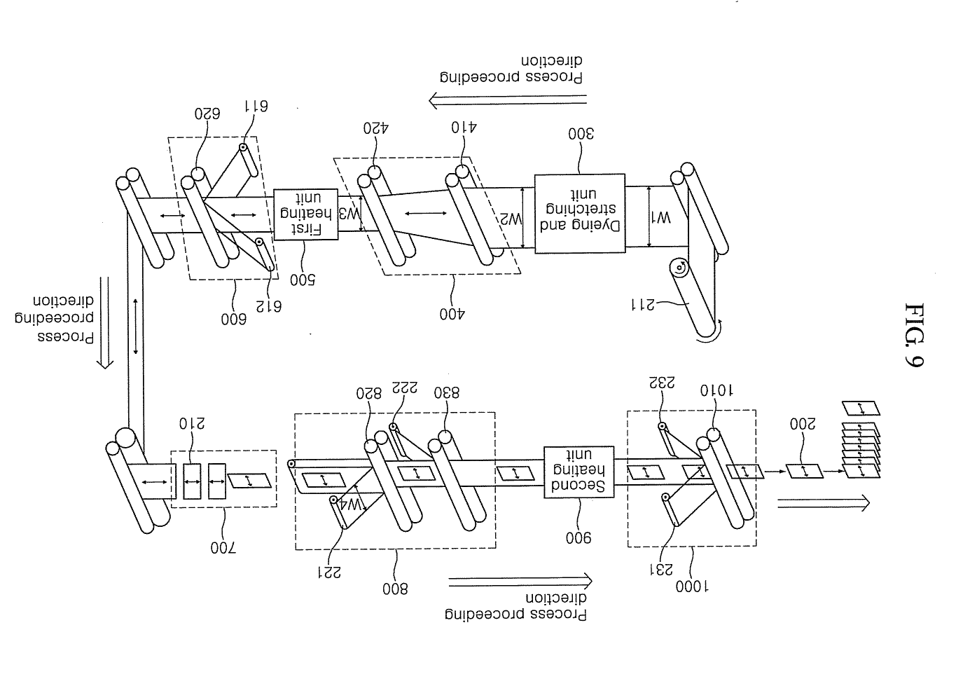

That is, the first and second protection films 231 and 232 for protecting the substructure (first TAC film/PVA sheet/second TAC film) are attached to the upper surface of the first TAC film 221 and the lower surface of the second TAC film 222, respectively, using an additional protection film attaching unit 1000. FIG. 8 is a perspective view illustrating a state of the polarizer after the first and second protection films 231 and 232 are attached to the upper surface of the first TAC film 221 and the lower surface of the second TAC film 222, respectively. Here, the widths of the first and second protection films 231 and 232 are preferably equal to those of the TAC films 221 and 222.

The protection film attaching unit 1000 includes the first and second protection films 231 and 232 wound in the form of rolls disposed above and below the TAC films 221 and 222, and rollers for attaching the first and second protection films 231 and 232 to the upper and lower surfaces of the TAC films 221 and 222.

Furthermore, a cutting means is installed in the protection film attaching unit 1000 to cut the TAC films 221 and 222 and the protection films 231 and 232 to the size of the PVA sheet 210. Accordingly, it is possible to manufacture a sheet type large-sized polarizer 200 with a light absorbing layer in the short side direction. The fabricated large-sized polarizer 200 is attached to the LCD panel 100.

In the aforementioned structure, a plurality of rollers may be provided at regions at which the films are bent.

This exemplary embodiment is not limited to the foregoing and other exemplary embodiments may be used to manufacture the polarizer. Hereinafter, these other exemplary embodiments will be described with reference to the accompanying drawings. Descriptions overlapping with the foregoing will be omitted.

FIG. 9 is a schematic illustration of another exemplary embodiment of a method for manufacturing a polarizer according to the present invention.

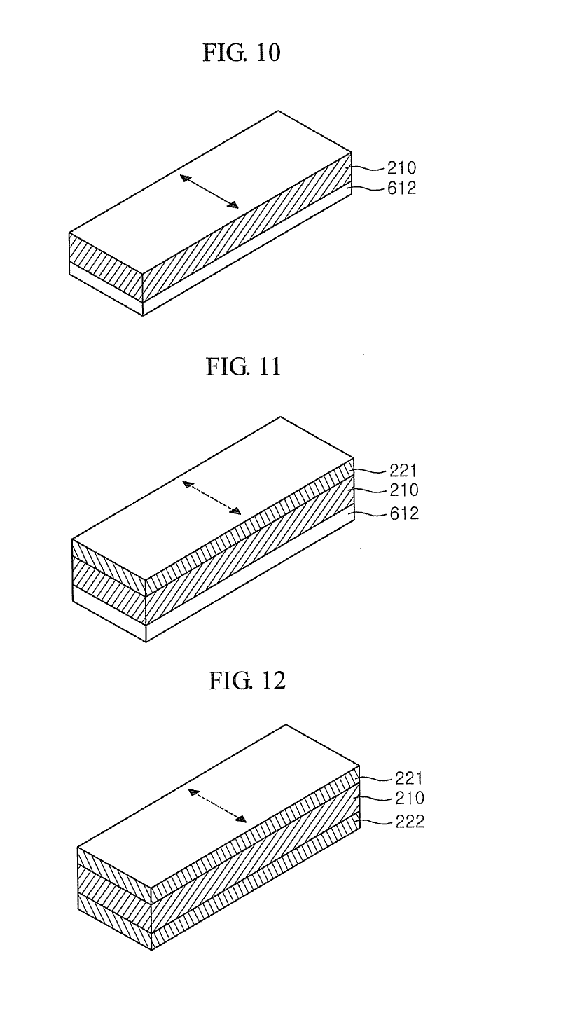

FIGS. 10 to 12 are conceptual cross-sectional views illustrating the polarizer during manufacture of the polarizer according to the method exemplified in FIG. 9.

Referring to FIGS. 9 to 12, a PVA film 211 unwound from a roll is dyed with a dichroic element and is stretched such that the PVA film has a width W3 equal to the length of a long side T1 of an LCD panel 100. PE films 611 and 612 are attached to surfaces of the stretched PVA film 211 and then cut into the length of a short side T2 of the LCD panel 100 to fabricate PVA sheets 210. Subsequently, the PE films 611 and 612 are removed from each of the PVA sheets 210, and TAC films 221 and 222 are attached to each of the PVA sheets 210.

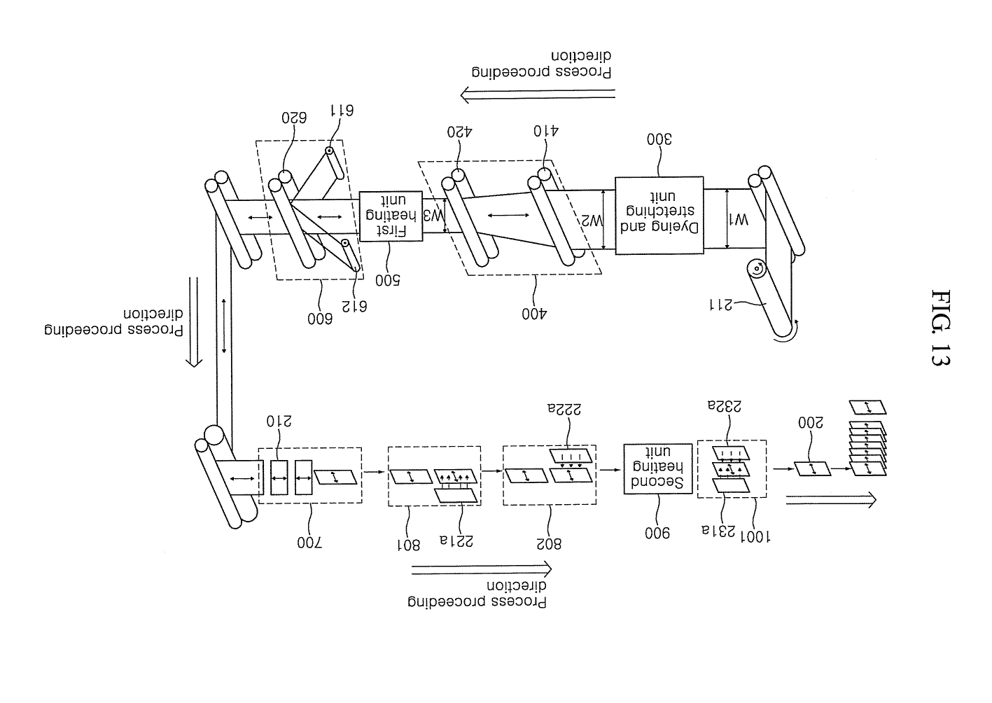

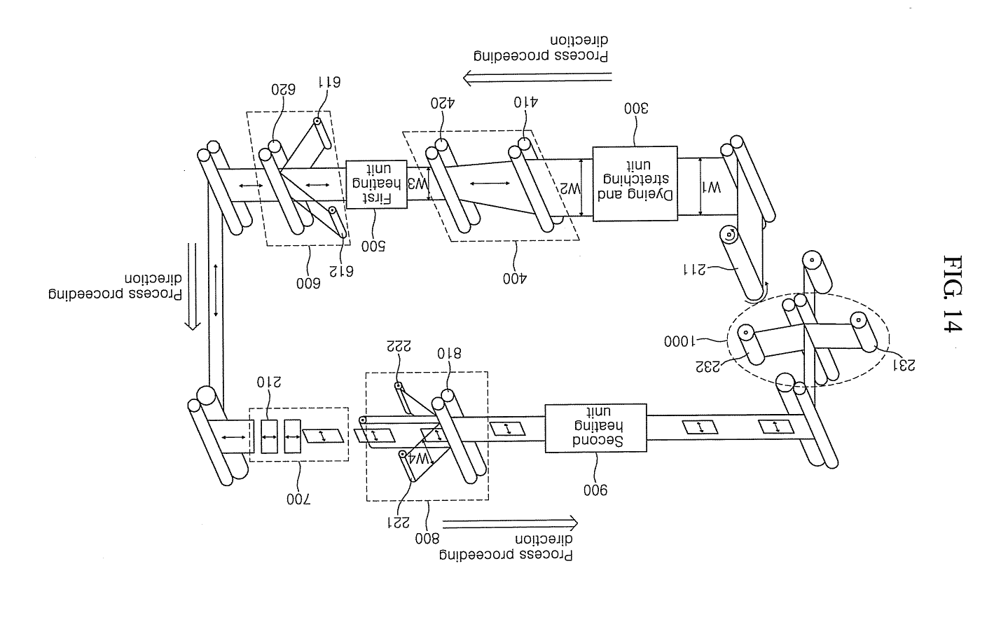

In this alternative exemplary embodiment, the PE film 611 on an upper surface of the PVA sheet 210 is removed as illustrated in FIG. 10 and the first TAC film 221 is then attached to the upper surface of the PVA sheet 210 as illustrated in FIG. 11. Subsequently, as illustrated in FIG. 12, the PE film 612 on the lower surface of the PVA sheet 210 is removed and the second TAC film 222 is then attached to the lower surface of the PVA sheet 210.

To this end, a TAC attaching unit 800 includes a first removal means (not shown) for removing the PE film 611 on the upper surface of the PVA sheet 210, a roll of the first TAC film 221 disposed above the PVA sheet 210, first rollers 820 for attaching the first TAC film 221 to the upper surface of the PVA sheet 210, a second removal means (not shown) for removing the PE film 612 from the lower surface of the PVA sheet 210, a roll of the second TAC film 222 disposed below the PVA sheet 210, and second rollers 830 for attaching the second TAC film 222 to the lower surface of the PVA sheet 210.

That is, the PVA film 211 is cut to the length of the short side T2 of the LCD panel 100, and the fabricated PVA sheets 210 are rotated by 90 degrees and then introduced into the TAC attaching unit 800 as illustrated in FIG. 9. Thereafter, the first removal means removes the PE film 611, the first rollers 820 attach the first TAC film 221 to the upper surface of each of the PVA sheets 210 from which the PE film 611 has been removed, the second removal means removes the PE film 612 attached to the lower surface of the PVA sheet, and the second rollers 830 attach the second TAC film 222 to the lower surface of the PVA sheet 220.

Subsequently, a second heating unit 900 heats the PVA sheet 210 to which the TAC films 221 and 222 have been attached. Then, protection films 231 and 232 are attached to upper and lower surfaces of the TAC films 221 and 222a and the combination of the TAC film and protection films is cut to fabricate a polarizer 200.

Furthermore, the method for manufacturing a polarizer is not limited thereto and may include preparing sheet types of TAC films and protection films and attaching them to the upper and lower surfaces of the PVA sheet.

FIG. 13 is a schematic illustration of another exemplary embodiment of a method for manufacturing a polarizer according to the present invention.

Referring to FIG. 13, a first heating unit 50 heats a PVA film 211 that has been dyed with a dichroic element and has a width W3 after two stretching processes that corresponds to the length of the long side TI of an LCD panel 100. PE films 611 and 612 are attached to the upper and lower surfaces of the PVA film, respectively, and the PVA film 211 with the PE films 611 and 612 attached thereto is cut to the length of a short side T2 of the LCD panel 100 to fabricate PVA sheets 210.

Subsequently, the PE film 611 on the upper surface of each of the PVA sheets 210 is removed and a first TAC sheet 221a is attached to the upper surface of the PVA sheet 210. The PE film 612 on the lower surface of the PVA sheet 210 is removed and a second TAC sheet 222a is attached to the lower surface of the PVA sheet 210. In this exemplary embodiment, the first and second TAC sheets 221a and 222a are fabricated by cutting TAC films 221 and 222 to the size of the PVA sheet. Preferably, the TAC films 221 and 222 are cut such that width of the TAC films 221 and 222 corresponds to the short side of the PVA sheet 210.

To this end, first and second TAC attaching units 801 and 802 are included in this exemplary embodiment. The first TAC attaching unit 801 includes a removal means for removing the PE film 611 on the upper surface of the PVA sheet 210, and a sheet attaching means for supplying the first TAC sheet 221a to the upper surface of the PVA sheet 210 and attaching the first TAC sheet 221a thereto. Furthermore, the second TAC attaching unit 802 includes a removal means for removing the PE film 612 on the lower surface of the PVA sheet 210, and a sheet attaching means for supplying the second TAC sheet 222a to the lower surface of the PVA sheet 210 and attaching the second TAC sheet 222a thereto. It will be apparent that the first and second TAC attaching units 801 and 802 may further include cutting means for cutting the TAC films 221 and 222 to fabricate the first and second TAC sheets 221a and 222a.

It will also be apparent that the first and second TAC attaching units 801 and 802 in this alternative exemplary embodiment are not limited thereto. Alternatively, the removal of the PE films 611 and 612 attached to the both surfaces of the PVA sheet 210 and the subsequent attachment of the first and second TAC sheets 221 a and 222a to the surfaces of the PVA sheet 210 may be performed using a single unit.

A second heating unit 900 heats the PVA sheet 210 with the first and second TAC sheets 221a and 222a attached thereto.

A first protection sheet 231a is attached to an upper surface of the first TAC sheet 221a and a second protection sheet 232a is attached to a lower surface of the second TAC sheet 222a using an additional protection sheet attaching unit 1001, thereby manufacturing a polarizer 200. Preferably, the protection sheets 231a and 232a are also cut to the same size as the TAC sheets 221a and 222a.

The protection sheet attaching unit 1001 includes an attaching means (not shown) for supplying the first and second protection sheets 231a and 232a to the upper and lower surfaces of the TAC sheets 221a and 222a and attaching the first and second protection sheets 231a and 232a thereto.

Furthermore, the TAC films and the protection films to be attached to the PVA sheet may be kept in a rolled state without being cut into sheets.

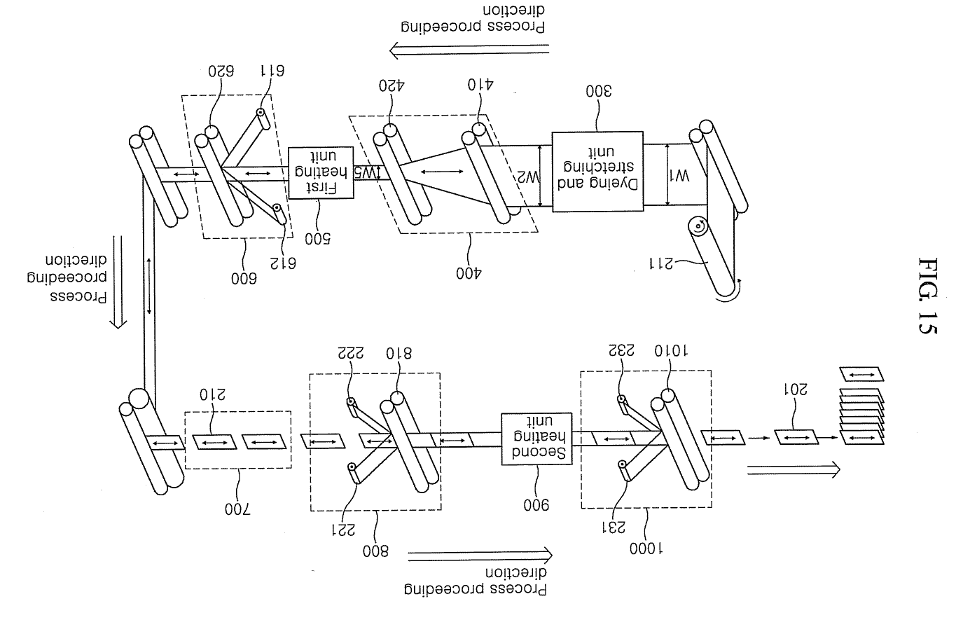

FIG. 14 is a schematic illustration of still another exemplary embodiment of a method for manufacturing a polarizer according to the present invention.

Referring to FIG. 14, a PVA film 211 is primarily stretched, the stretched PVA film is dyed with a dichroic element, and the dyed PVA film is secondarily stretched and subjected to heat treatment. The PVA film 211 has a width through the primary and secondary stretching equal to the length of the long side T1 of an LCD panel 100. First and second PE films 611 and 612 are attached to upper and lower surfaces, respectively, of the PVA film 211.

The PVA film 211 is cut to the length of a short side T2 of the LCD panel 100 to fabricate PVA sheets 210. At this time, the lengths of long and short sides of each of the PVA sheets 210 are equal to the lengths of the long and short sides T1 and T2 of the LCD panel 100, and a light absorbing layer is formed in a direction parallel to the short side of the PVA sheet 210.

Subsequently, the PVA sheet 210 is rotated 90 degrees and the first and second PE films 611 and 612 are removed from the surfaces of the PVA sheet 210. First and second TAC films 221 and 222 are attached to upper and lower surfaces, respectively, of the PVA sheet 210, and the PVA sheet with the TAC films attached thereto is heated.

Thereafter, a first protection film 231 is attached to an upper surface of the first TAC film 221, and a second protection film 232 is attached to a lower surface of the second TAC film 222.

Then, a polarizer film in which the TAC films 221 and 222 and the protection films 231 and 232 are attached to the PVA sheet 210 is wound in a roll shape. The PVA sheet 210 of the polarizer film wound in a roll shape is disposed to correspond to the LCD panel 100, and the periphery of the PVA sheet is cut so that a polarizer 200 can be attached to an LCD panel 100.

In the exemplary embodiment described above, it is possible to manufacture a polarizer capable of coping with an increase in the size of an LCD without having additional fabrication facilities for increasing the width of the TAC film or protection film.

Although the exemplary methods for manufacturing a polarizer have been described mainly in connection with the fabrication of the first polarizer 200, they are not limited thereto. A second polarizer 201 with a light absorbing layer provided in a direction parallel to the long side of the polarizer may also be fabricated using the aforementioned exemplary fabrication methods. Next, a method for manufacturing a polarizer according to another embodiment of the present invention will be described. Descriptions overlapping with the foregoing will be omitted.

FIG. 15 is a schematic illustration of yet another exemplary embodiment of a method for manufacturing a polarizer according the present invention.

Referring to FIG. 15, a dichroic element is dyed on a surface of a PVA film 211 unwound from a roll, and the dyed PVA film 211 is successively subjected to primary stretching and secondary stretching, thereby fabricating a PVA film 211 that has a fifth width W5 and is formed with a light absorbing layer in a stretching direction.

In exemplary embodiments, the fifth width W5 is equal to or larger than the length of a short side T2 of an LCD panel 100 and smaller than the length of a long side Ti of the LCD panel 100. In this exemplary embodiment, the PVA film 211 is stretched to have a width equal to the length of the short side T2 of the LCD panel 100. The PVA film 211 is provided with a light absorbing layer in a stretching direction. That is, the light absorbing layer is formed longitudinally on the PVA film 211.

Subsequently, the PVA film is heated to remove moisture therefrom using a first heating unit 500, and PE films 611 and 612 are attached to upper and lower surfaces of the PVA film 211 having the fifth width W5.

The PVA film 211 with the PE films 611 and 612 attached to the upper and lower surfaces thereof is cut by a cutting unit 700 to form PVA sheets 210. The PVA sheets 210 are fabricated by cutting the PVA films 211 to which the PE films 611 and 612 are attached to the length of the long side TI of the LCD panel 100. If the width of the PVA films 211 to which the PE films 611 and 612 are attached after the stretching processes is larger than the length of the short side T2 of the LCD panel 100, the PVA sheets 210 may be fabricated by cutting the PVA film 211 to conform to the size of the LCD panel 100. Each of the PVA sheets 210 has long and short sides equal to the lengths of the long and short sides T1 and T2 of the LCD panel 100, and is provided with a light absorbing layer in the long side direction. After the PVA film is cut into the PVA sheets 210, the PE films 611 and 612 attached to upper and lower surfaces of the PVA sheet 210 are removed.

The first and second TAC films 221 and 22 are attached to the upper and lower surfaces of the PVA sheet 210 from which the PE films 611 and 612 have been removed.

Preferably, the width of the first and second TAC films 221 and 222 are equal to the length of the short side of the PVA sheet 210. It will be apparent that the width of the first and second TAC films 221 and 222 may be larger than the length of the short side of the PVA sheet 210. The TAC films 221 and 222 are attached to the PVA sheet 210 and then cut. Alternatively, it is possible to perform a subsequent process in a film state as illustrated in the figure.

The PVA film to which the first and second TAC films 221 and 222 have been attached is heated by a second heating unit 900. First and second protection films 231 and 232 are attached to the first and second TAC films 221 and 222, respectively. The film is then cut to the size of the PVA sheet 210 to manufacture a sheet type polarizer 201.

Of course, the foregoing method for manufacturing a polarizer is not limited thereto. A polarizer may be manufactured by sequentially attaching the TAC films and protection films to the PVA film, which has a light absorbing layer longitudinally formed through the stretching process, and by cutting the PVA film.

In the foregoing, the PVA film is dyed with a dichroic element such as iodine or dye and then stretched to have a light absorbing layer capable of absorbing polarized light in a stretching direction. However, the present invention is not limited thereto. A light absorbing layer may be prepared in a direction perpendicular to the stretching direction of the PVA film. Hereinafter, a further exemplary embodiment of a method for manufacturing a polarizer according to the present invention will be described. Descriptions overlapping with the foregoing will be omitted.

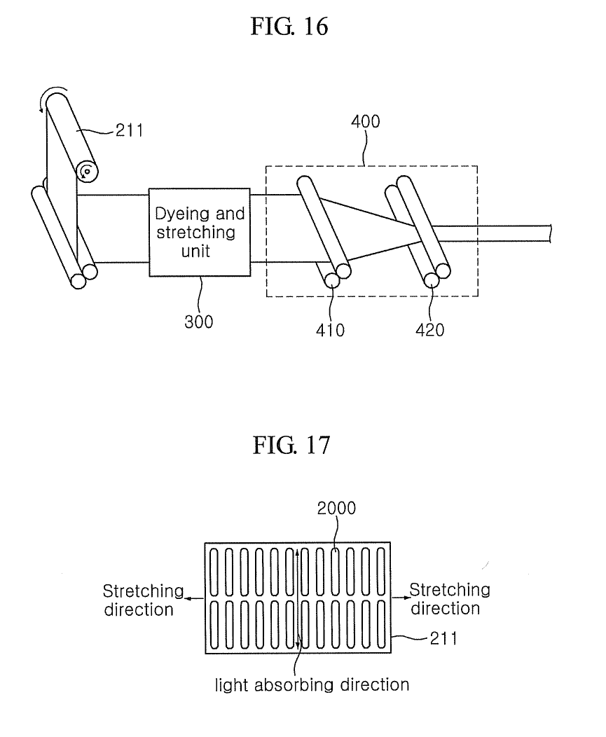

FIG. 16 is a schematic illustration of a further exemplary embodiment of a method for manufacturing a polarizer according to of the present invention. FIG. 17 is an enlarged view of a circled portion of the polarizer in FIG. 16.

Referring to FIGS. 16 and 17, a dichroic element 2000 is dyed on the surface of a PVA film 211 that in turn is stretched in a direction perpendicular to a width direction of the PVA film, i.e., a stretching direction of the PVA film, to prepare a light absorbing layer. To this end, a dichroic element 2000 of which orientation angle is changed during stretching is used. It is desirable to use a material with a side chain component that is rotated by about 90 degrees when energy of the dichroic element 2000 is changed.

Accordingly, when the width of the stretched PVA film 211 is equal to the length of a short side T2 of an LCD panel 100, it is possible to manufacture polarizers 200 and 201 corresponding to an LCD panel 100 with a size of 100 inches or more. In the polarizers 200 and 201 formed on upper and lower surfaces of the LCD panel 100 as illustrated in FIG. 1, it is easy to manufacture the polarizer 201 having a light absorbing layer formed in a direction parallel to the long side T1, whereas it is difficult to manufacture the polarizer 200 having a light absorbing layer formed in a direction perpendicular to the long side T1. However, the polarizer 200 having a light absorbing layer formed in the direction perpendicular to the long side T1 can be easily manufactured by using the PVA film 211 having a light absorbing layer deviated by 90 degrees from the stretching direction as in the present exemplary embodiment. If the width of the stretched PVA film 211 corresponds to the length of the short side T2 of the LCD panel 100, the PVA film 211 unwound from a roll is simply cut to the length of the long side T1 of the LCD panel 100, thereby the polarizer 200 having a light absorbing layer formed in the direction perpendicular to the long side T1 of the LCD panel 100.

Furthermore, the method for manufacturing a polarizer according to the present invention is not limited thereto, and the polarizer may be fabricated by means of a roll-to-roll process of fabricating a roll of polarizer 200 by attaching TAC films 221 and 222 and protection films 231 and 232 unwound from rolls to a PVA film 211 unwound from a roll without cutting the PVA film 211 into sheets.

As described above, according to the present invention, it is possible to manufacture large-sized polarizers with light absorbing layers perpendicular to each other by controlling the degree of stretching of a PVA film to adjust the width of the PVA film and cutting the stretched PVA film to a size corresponding to a large-sized LCD panel.

Furthermore, according to the present invention, it is possible to prevent damage to the PVA film upon cutting of the PVA film by attaching PE films to the surfaces of the PVA film.

Moreover, according to the present invention, it is possible to manufacture a polarizer without changing the width of a TAC film or protection film by cutting the PVA film into sheets. Accordingly, costs associated with facility investment can be reduced.

Although the present invention has been illustrated and described in connection with exemplary embodiments and the accompanying drawings, it is not limited thereto and is defined by the appended claims. Accordingly, it will be readily understood by those skilled in the art that various modifications and changes can be made thereto without departing from the spirit and scope of the present invention defined by the appended claims.

What is claimed is:

1. A method for manufacturing a polarizer for a liquid crystal display (LCD) panel, the method comprising:
preparing a polyvinyl alcohol (PVA) film;
dyeing a dichroic element on a surface of the PVA film and stretching the dyed PVA film to have a width corresponding to a long side of the LCD panel;
fabricating a PVA sheet by cutting the stretched PVA film to the length of a short side of the LCD panel; and
sequentially attaching triacetyl cellulose (TAC) films and protection films on upper and lower surfaces of the PVA sheet.

2. The method as claimed in claim 1, wherein the attaching the TAC films to the upper and lower surfaces of the PVA sheet comprises:
attaching the TAC films unwound from rolls to the upper and lower surfaces of the PVA sheet; and
removing portions of the TAC films outside the PVA sheet.

3. The method as claimed in claim 2,, further comprising:
causing a short side of the PVA sheet to correspond to the width of the TAC films unwound from the rolls before the attaching the TAC films unwound from the rolls to the upper and lower surfaces of the PVA sheet.

4. The method as claimed in claim 1, wherein the attaching the TAC film to the upper and lower surfaces of the PVA sheet comprises:
fabricating TAC sheets by cutting the TAC films unwound from the rolls to the size of the LCD panel; and
attaching the TAC sheets to the upper and lower surfaces of the PVA sheet.

5. The method as claimed in claim 1, wherein the attaching the protection films to the TAC films attached to the PVA sheet comprises:
attaching the protection films unwound from rolls to exposed upper and lower surfaces of the TAC films; and
removing portions of the protection films outside the PVA sheet.

6. The method as claimed in claim 1, wherein the attaching the protection films to the TAC films attached to the PVA sheet comprises:
fabricating protection sheets by cutting the protection films unwound from the rolls to the size of the LCD panel; and
attaching the protection sheets to exposed upper and lower surfaces of the TAC films.

7. The method as claimed in claim 1, further comprising attaching PE films to the upper and lower surfaces of the PVA film after the stretching the PVA film.

8. The method as claimed in claim 7, further comprising removing the PE films after the fabricating the PVA sheet.

9. The method as claimed in claim 7, wherein the attaching the TAC films to the upper and lower surfaces of the PVA sheet comprises:
removing one of the PE films on any one of the upper and lower surfaces of the PVA film;
attaching one of the TAC films to the surface of the PVA film from which the PE film has been removed;
removing the other PE film remaining on the other surface of the PVA film; and
attaching the other TAC film to the other face of the PVA film from which the other PE film has been removed.

10. The method as claimed in claim 1, further comprising winding a PVA sheet with the TAC films and the protection films sequentially attached to the upper and lower surfaces thereof into a roll shape.

11. The method as claimed in claim 1, wherein the width of the stretched PVA film is about 1 percent to about 30 percent larger than the length of the long side of the LCD panel.

12. The method as claimed in claim 1, wherein the dichroic element is arranged in a direction in which the PVA film is stretched.

13. A method for manufacturing a polarizer for an LCD panel, the method comprising:
preparing a PVA film;
dyeing a dichroic element on a surface of the PVA film and stretching the dyed PVA film to form a light absorbing layer in a direction perpendicular to the stretching direction; and
sequentially attaching TAC films and protection films to upper and lower surfaces of the stretched PVA film.

14. The method as claimed in claim 13, wherein a width of the stretched PVA film corresponds to a length of a short side of the LCD panel, and the PVA film with the TAC films and protection films attached thereto is cut to a length of a long side of the LCD panel.

15. The method as claimed in claim 13, wherein the polarizer is manufactured by means of a roll-to-roll process.

16. A method for manufacturing a polarizer for an LCD, the method comprising:
preparing a PVA film with a first width larger than a long side of the LCD, TAC films with a second width smaller than a long side of the LCD, and protection films with a third width smaller than the long side of the LCD;
stretching the PVA film with the first width to form a PVA film with a fourth width equal to or larger than the long side of the LCD;
cutting the PVA film with the fourth width to a length smaller than the second and third widths; and
attaching the TAC films with the second width and the protection films with the third width to upper and lower surfaces of the cut PVA film.

17. The method as claimed in claim 16, wherein the length smaller than the second and third widths is equal to or larger than the length of a short side of the LCD.

18. The method as claimed in claim 16, wherein the second width and the third width are equal to the length of a short side of the LCD.

19. The method as claimed in claim 16, wherein the first width is about 2,000 mm to about 4,000 mm, and the fourth width is about 1,000 mm to about 3,000 mm.
